(19) United States
(12) Patent Application Publication
(10) Pub. No.: US 2020/0231303 A1
(43) Pub. Date: Jul. 23, 2020

(54) TOWING VEHICLE SYSTEM

(71) Applicant: KABUSHIKI KAISHA TOYOTA JIDOSHOKKI, Kariya-shi (JP)

(72) Inventor: Hiroyuki FUJIMORI, Aichi-ken (JP)

(73) Assignee: KABUSHIKI KAISHA TOYOTA JIDOSHOKKI, Kariya-shi (JP)

(21) Appl. No.: 16/740,079

(22) Filed: Jan. 10, 2020

(30) Foreign Application Priority Data
Jan. 23, 2019 (JP) 2019-008870

(51) Int. Cl. B64F 1/32; B60K 1/04; B25J 5/00

(52) U.S. Cl. CPC B64F 1/32; B25J 5/00; B60K 1/04

(57) ABSTRACT

A towing vehicle system includes a towing vehicle and a towed vehicle pulled by the towing vehicle. The towed vehicle includes a placement portion on which a cargo handling robot that is rechargeable is mounted, a power supply source mounted on the towed vehicle and configured to supply electric power to the cargo handling robot, and a power controller configured to control supply of electric power from the power supply source. While the cargo handling robot mounted on the placement portion is in no operation state, the power controller supplies electric power to and charges the cargo handling robot.

### CROSS-REFERENCE TO RELATED APPLICATION

This application claims priority to Japanese Patent Application No. 2019-008870 filed on Jan. 23, 2019, the entire disclosure of which is incorporated herein by reference.

### BACKGROUND ART

The present disclosure relates to a towing vehicle system including a towing vehicle and a towed vehicle pulled by the towing vehicle.

For example, an airport is known as a cargo workspace, where a cargo work of air cargoes for an airplane is performed. Specifically, a towing tractor corresponding to a towing vehicle pulls a trailer on which air cargoes are mounted. An operator performs a cargo work on a trailer and a conveyor.

Japanese Patent Application Publication No. 2014-158335 discloses a towing type carrying vehicle, which has been known as a conventional technique for a towing vehicle system. The towing type carrying vehicle disclosed in the Publication No. 2014-158335 includes a towed vehicle on which cargoes are placed and a towing vehicle travelling and pulling the towed vehicle. The towed vehicle includes a first secondary battery, a second secondary battery, and an electric motor driven by electric power. The towed vehicle includes a third secondary battery. The towing vehicle also includes a control unit controlling charge and discharge of the secondary batteries in the towing vehicle and the towed vehicle. The control unit discharges the first secondary battery, driving the electric motor by the power discharged from the first secondary battery. Furthermore, the control unit discharges the third secondary battery, charging the first secondary battery or the second secondary battery by the power discharged from the third secondary battery.

By the way, in a workspace where a cargo work is performed, automation and manpower-saving have been required considering a present situation of labor shortage. Thus, introduction of a cargo handling robot or the like is expected to promote automation and manpower-saving. To achieve this, carrying of the cargo handling robot to a cargo workspace and supplying power to the cargo handling robot are required. In a case where the cargo handling robot needs to be carried to a cargo workspace, a rechargeable cargo handling robot has a great convenience by reason that the rechargeable cargo handling robot does not need electrical wiring. However, a rechargeable cargo handling robot has a difficulty in charging in a short time. On the other hand, a towing type carrying vehicle disclosed in the Publication No. 2014-158335 merely suppresses reduction in charge rate of the secondary battery mounted on the towing vehicle even if the towing vehicle continuously travels.

The present disclosure has been made in view of the above circumstances and is directed to a towing vehicle system effectively charging a cargo handling robot.

### SUMMARY

In accordance with an aspect of the present disclosure, there is provided a towing vehicle system including a towing vehicle and a towed vehicle pulled by the towing vehicle. The towed vehicle includes a placement portion on which a cargo handling robot that is rechargeable is mounted, a power supply source mounted on the towed vehicle and configured to supply electric power to the cargo handling robot, and a power controller configured to control supply of electric power from the power supply source. While the cargo handling robot mounted on the placement portion is in no operation state, the power controller supplies electric power to and charges the cargo handling robot.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view schematically showing a towing vehicle system according to an embodiment of the present disclosure;

FIG. 2 is a plan view schematically showing the towing vehicle system according to the embodiment of the present disclosure;

FIG. 3 is a side view schematically showing a towed vehicle;

FIG. 4 is a plan view showing a state in which a train of towing and towed vehicles are on standby at a starting point;

FIG. 5 is a plan view showing a state in which trailers are disconnected from the train of towing and towed vehicles in a cargo workspace for loading cargoes;

FIG. 6 is a plan view showing the train of towing, and towed vehicles, from which the trailers are disconnected, leaving for another cargo workspace;

FIG. 7 is a plan view showing a state in which the trailers are connected to the train of towing and towed vehicles after a cargo work in the cargo workspace is completed; and

FIG. 8 is a plan view showing a state in which the trailers are disconnected from the train of towing and towed vehicles in another cargo workspace for unloading the cargoes.

### DETAILED DESCRIPTION OF THE EMBODIMENTS

The following will describe a towing vehicle system according to an embodiment of the present disclosure with reference to the accompanying drawings. The towing vehicle system of the present embodiment is an exemplary embodiment including a towing tractor as a towing vehicle used in an airport, a towed vehicle pulled by the towing tractor, and a trailer as a carrying cart on which air cargoes are placed.

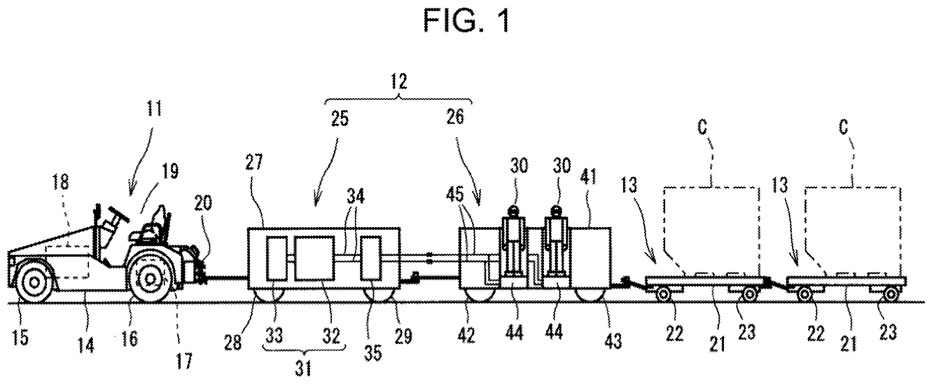

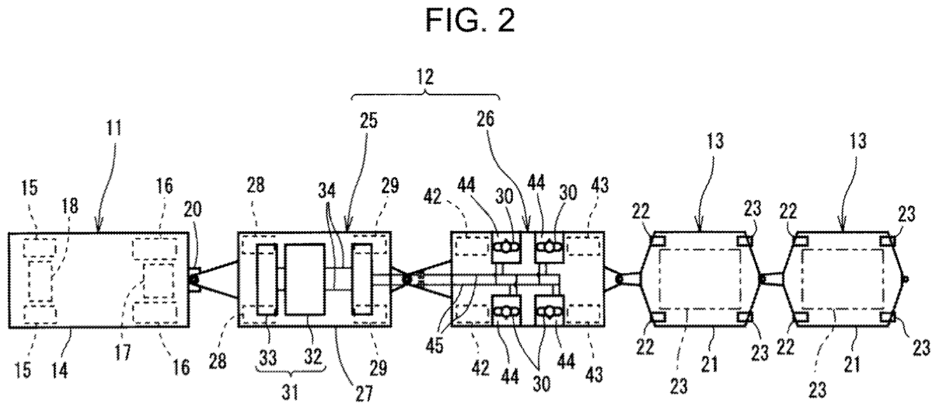

Referring to FIG. 1 and FIG. 2, the towing vehicle system of the present embodiment includes a towing tractor 11 as the towing vehicle in the present disclosure, a towed vehicle 12, and trailers 13. The towing tractor 11 has steering wheels 15 as front wheels and driving wheels 16 as rear wheels in a front portion and a rear portion of a vehicle body 14 of the towing tractor 11, respectively. An electric motor 17 for travelling and a battery 18 that is rechargeable and dischargeable are mounted on the vehicle body 14. The vehicle body 14 includes a drivers seat 19 and a drawbar device 20 disposed behind the drivers seat 19 to connect the towing tractor 11 to the towed vehicle 12 and the trailers 13.

The towed vehicle 12 will be described later in detail, and the trailers 13 as the carrying cart in the present disclosure will be firstly described. Each of the trailers 13 of the present embodiment is so-called a container dolly, on which containers C corresponding to air cargoes are mounted. The containers C correspond to objects to be loaded and unloaded in the present disclosure. Referring to FIG. 2, a vehicle body 21 of each trailer 13 includes a pair of left and right front wheels 22 and a pair of left and right rear wheels 23. The front wheels 22 and the rear wheels 23 of each of the trailers 13 are idly rotatable. In addition, the front wheels 22 may be oriented to all directions. The upper portion of the vehicle body 21 of each of the trailers 13 is a cargo bed on which the containers C are placed.

The following will describe the towed vehicle 12 The towed vehicle 12 of the present embodiment includes a power supply vehicle 25 connected to the towing tractor 11 and a cargo handling robot mounting vehicle 26 connected to the power supply vehicle 25. Referring to FIG. 2, a vehicle body 27 of the power supply vehicle 25 includes a pair of left and right front wheels 28 and a pair of left and right rear wheels 29. The front wheels 28 and the rear wheels 29 of the power supply vehicle 25 are idly rotatable. In addition, the front wheels 28 may be oriented to all directions.

A power supply device 31 as the power supply source in the present disclosure is mounted on the vehicle body 27 of the power supply vehicle 25 and configured to supply electric power to cargo handling robots 30. The power supply device 31 includes a power storage apparatus 32 and a self-power generating device 33 that self-generates electric power. The power storage apparatus 32 is, for example, a lithium ion secondary battery. The self-power generating device 33 of the present embodiment includes a power generator (not shown) and a diesel engine (not shown) driving the power generator. The vehicle body 27 of the power supply vehicle 25 has a power line 34 through which electric power from the self-power generating device 33 is supplied to the power storage apparatus 32, and electric power stored in the power storage apparatus 32 is supplied to the cargo handling robot mounting vehicle 26. A fuel cell may be used as the self-power generating device 33 instead of the power generator and the diesel engine.

A power controller 35 is mounted in the vehicle body 27 of the power supply vehicle 25. The power controller 35 has a function of adjusting electric power of the power storage apparatus 32 that is supplied to the cargo handling robot mounting vehicle 26. Specifically, the power controller 35 adjusts voltage of the supply power in accordance with a type of the cargo handling robots 30 as well as distributes electric power to the plurality of cargo handling robots 30. The vehicle body 27 of the power supply vehicle 25 includes a power line (not shown) connected to the electric motor 17 of the towing tractor 11 for travelling. Accordingly, the power controller 35 has a function of controlling supply of electric power from the power supply device 31 to the electric motor 17 of the towing tractor 11 for travelling.

The following will describe the cargo handling robot mounting vehicle 26. The cargo handling robot mounting vehicle 26 has functions of mounting the cargo handling robots 30 and of charging the cargo handling robots 30 mounted in no operation state. Referring to FIG. 2, a vehicle body 41 of the cargo handling robot mounting vehicle 26 includes a pair of left and right front wheels 42 and a pair of left and right rear wheels 43. The front wheels 42 and the rear wheels 43 of the cargo handling robot mounting vehicle 26 are idly rotatable. In addition, the front wheels 42 may be oriented to all directions.

The vehicle body 41 of the cargo handling robot mounting vehicle 26 includes in an upper portion thereof a plurality of placement portions 44 on which the cargo handling robots 30 that are rechargeable are mounted. A power-transmitting coil (not shown) that performs contactless charging of the cargo handling robots 30 is embedded in each placement portion 44. The contactless power supply method of the placement portions 44 is a magnetic resonance method. The vehicle body 41 has a power line 45 connected to the power-transmitting coil in each placement portion 44. The power line 45 is connected to the power line 34 of the power supply vehicle 25. In the present embodiment, the placement portions 44 are lowered down near a road surface to help the cargo handling robots 30 to get on and off the cargo handling robot mounting vehicle 26.

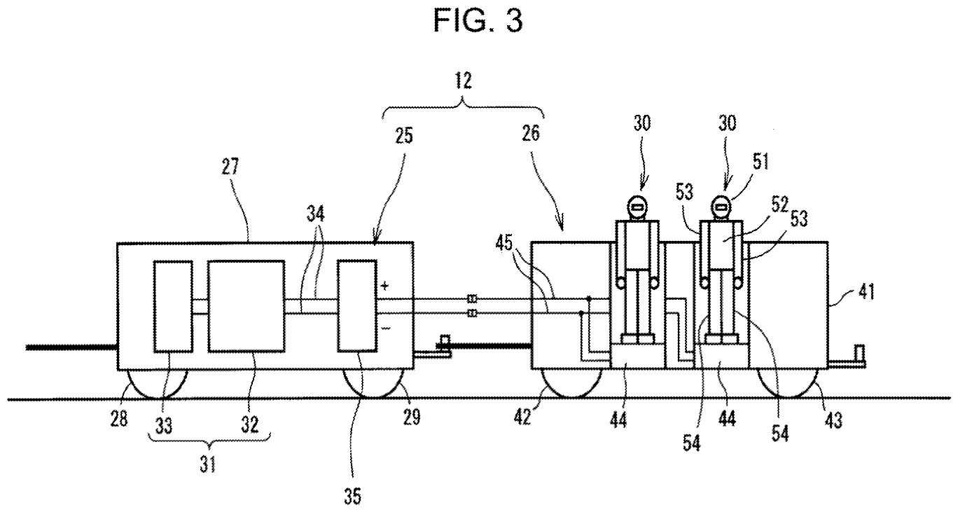

The following will describe the cargo handling robots 30. Referring to FIG. 3, each cargo handling robot 30 of the present embodiment is a biped walking humanoid and has a head portion 51, a body portion 52, arm portions 53, and leg portions 54. Thee cargo handling robots 30 are program-controlled so as to autonomously perform a variety of works including a predetermined cargo work. Specifically, the cargo handling robots 30 move to a workspace for a cargo work from the cargo handling robot mounting vehicle 26, and then, load the containers C to the trailers 13 and unload the containers C from the trailers 13. The cargo handling robots 30 also disconnect the trailers 13 from the train of towing and towed vehicles in which the towing tractor 11 is at the top and connect the trailers 13 to the train of towing and towed vehicles. The train of towing and towed vehicles means a vehicle group including at least the towing tractor 11 as the towing vehicle and the towed vehicle 12 pulled by the towing tractor 11.

Each cargo handling robot 30 includes an internal battery (not shown) that is rechargeable and a power-receiving coil (not shown) to receive power supply without contact. The power-receiving coil is embedded in an end portion of each leg portion 54 so as to face the power-transmitting coil for transmitting power of each placement portion 44. The power-receiving coils are connected to the internal battery by a power line (not shown). The cargo handling robots 30 on the placement portions 44 may be charged by connection with connector instead of contactless charging.

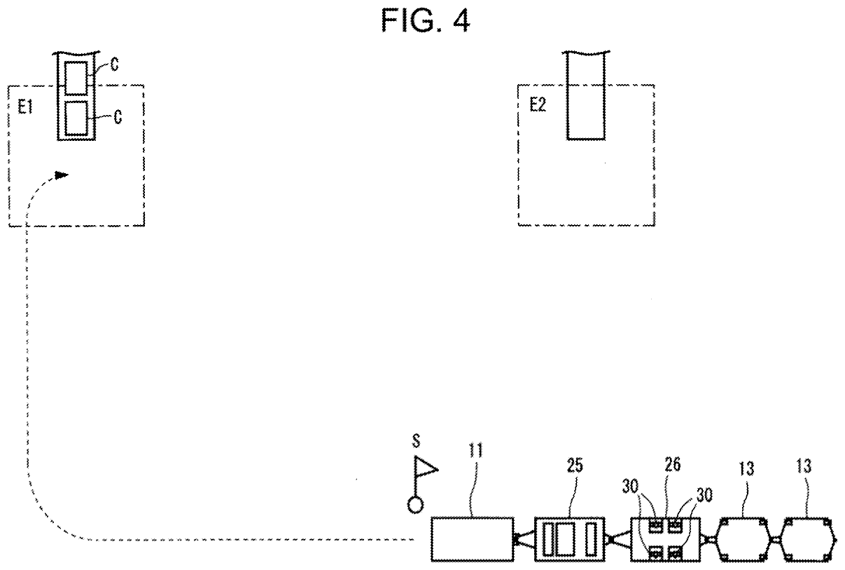

The following will describe loading and unloading by the towing vehicle system according to the present embodiment. Firstly, a case where the containers C are loaded onto the trailers 13 in a cargo workspace E1 will be described. Referring to FIG. 4, the power supply vehicle 25 is connected to the towing tractor 11, and the cargo handling robot mounting vehicle 26 is connected to the power supply vehicle 25 at a starting point S of the towing tractor 11. The plurality of trailers 13 are connected to the cargo handling robot mounting vehicle 26. The plurality of cargo handling robots 30 are mounted on the placement portions 44 of the cargo handling robot mounting vehicle 26. The plurality of trailers 13 each has no container C thereon. The cargo handling robots 30 mounted on the cargo handling robot mounting vehicle 26 are in no operation state. In this time, the contactless charging of the cargo handling robots 30 is started.

An operator travels the towing tractor 11 to the cargo workspace E1 The towing tractor 11 travels, pulling the power supply vehicle 25, the cargo handling robot mounting vehicle 26, and the plurality of trailers 13. While the towing tractor 11 travels, the cargo handling robots 30 mounted on the cargo handling robot mounting vehicle 26 are in no operation state, and the contactless charging of the cargo handling robots 30 is continued.

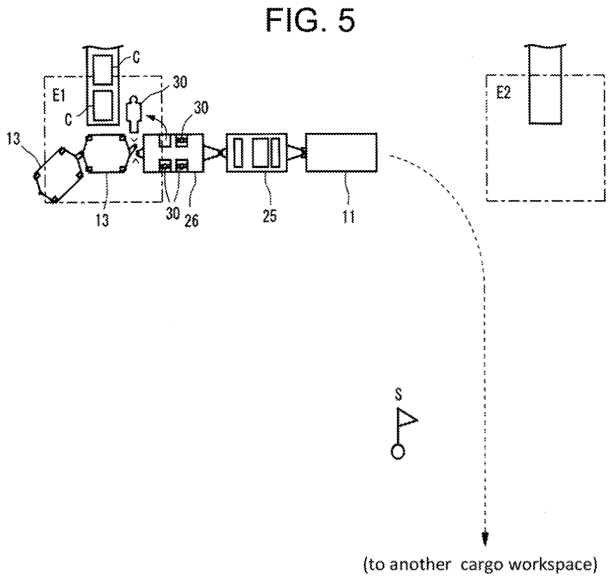

Referring to FIG. 5, when the train of towing and towed vehicles in which the towing tractor 11 is at the top arrives at the cargo workspace E1, the operator stops the train of towing and towed vehicles. After the train of towing and towed vehicles is stopped, the cargo handling robots 30 get off the cargo handling robot mounting vehicle 26. While the charge of the cargo handling robots 30 to get off is interrupted before the cargo handling robots 30 get off the cargo handling robot mounting vehicle 26, the charge of the other cargo handling robots 30 not to get off is continued. The cargo handling robots 30 that have got off disconnect the plurality of trailers 13 from the train of towing and towed vehicles. After disconnecting the plurality of trailers 13 from the train of towing and towed vehicles in the cargo workspace E1, the cargo handling robots 30 perform a cargo work for loading the containers C onto the trailers 13.

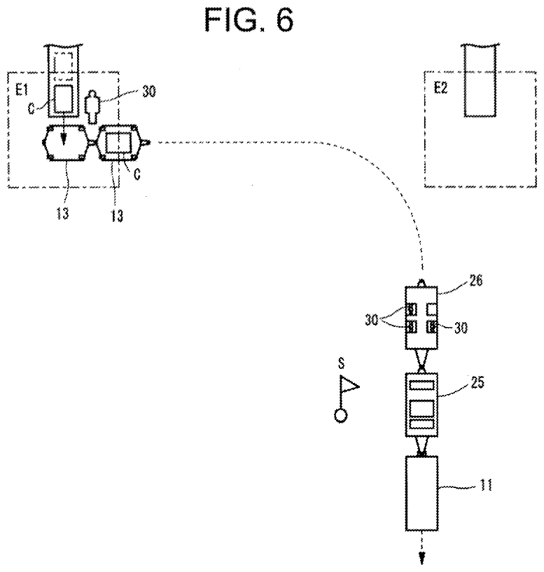

Referring to FIG. 6, the operator goes, away from the cargo workspace E1 by driving the towing tractor 11 after the plurality of trailers 13 are disconnected from the train of towing and towed vehicles. The operator then goes to receive the trailers 13 on which the containers C has been loaded in another cargo workspace (not shown), or the trailers 13 on which nothing is placed. In this case, the cargo handling robots 30 mounted on the cargo handling robot mounting vehicle 26 during travelling are in no operation state so that the contactless charging of the cargo handling robots 30 is continued. When the train of towing and towed vehicles arrives at a receiving destination of the trailers 13, the operator gets the other cargo handling robots 30 off the cargo handling robot mounting vehicle 26. A connecting work of the trailers 13 is to be performed by the cargo handling robots 30 that have got off.

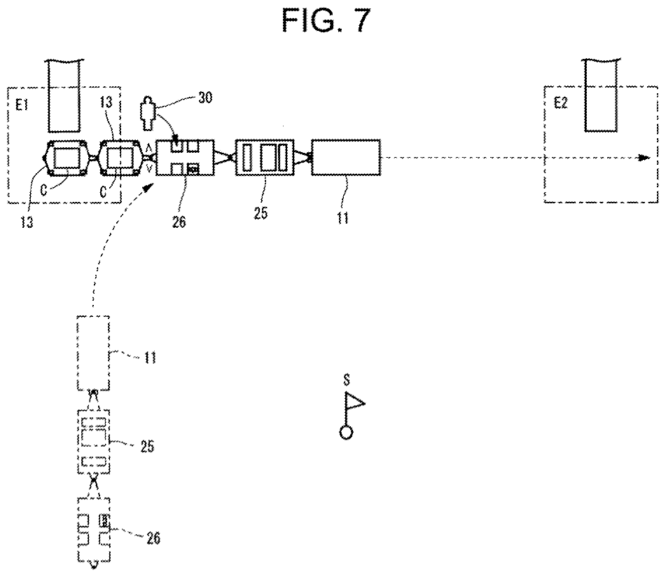

After the cargo work for loading the containers C onto the hailers 13 by the cargo handling robots 30 in the cargo workspace E1 has been completed, the operator travels the train of towing and towed vehicles in which the towing tractor 11 is at the top to the cargo workspace E1. Referring to FIG. 7, when the train of towing and towed vehicles arrives at the cargo workspace E1, the cargo handling robots 30 that have completed the cargo work connect the trailers 13 on which the containers C are loaded to the train of towing and towed vehicles. After connecting the trailers 13 to the train of towing and towed vehicles, the cargo handling robots 30 get on the placement portions 44 of the cargo handling robot mounting vehicle 26, on which nothing is placed.

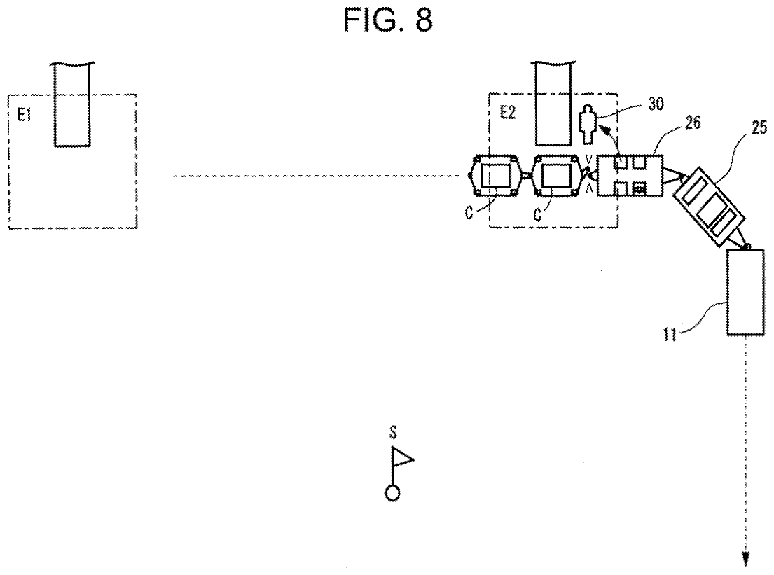

After the cargo handling robots 30 return back to the placement portions 44, the operator moves the train of towing and towed vehicles in which the towing tractor 11 is at the top to a cargo workspace E2 where the containers C are to be unloaded. Referring to FIG. 8, when the train of towing and towed vehicles arrives at the cargo workspace E2, the operator gets the cargo handling robots 30 that have been charged off the cargo handling robot mounting vehicle 26. The cargo handling robots 30 that have got off disconnect the plurality of trailers 13 from the train of towing and towed vehicles. After disconnecting the plurality of trailers 13 from the train of towing and towed vehicles in the cargo workspace E2, the cargo handling robots 30 perform a cargo work for unloading the containers C from the trailers

In the present embodiment, the cargo handling robots 30 are program-controlled so as to get off the cargo handling robot mounting vehicle 26 in the cargo workspaces E1, E2. However, the cargo handling robots 30 may perform a cargo work depending on a type of the cargo handling robots 30 while remaining on the placement portions 44. In this case, the operator performs the disconnecting of the trailers 13 from the train of towing and towed vehicles and the connecting of the trailers 13 to the train of towing and towed vehicles. In an operation state in which the cargo handling robots 30 perform a cargo work, even if the cargo handling robots 30 are placed on the placement portions 44, the charging of the cargo handling robots 30 in an operation state is interrupted.

In the present embodiment, the cargo handling robots 30 mounted on the placement portions 44 in no operation state are always charged while towing tractor 11 are connected to the power supply vehicle 25. However, the present disclosure is not limited to this embodiment. Even if the towing tractor 11 is not connected to the power supply vehicle 25, the cargo handling robots 30 may be charged, in other words, regardless of whether or not the towing tractor 11 is connected to the power supply vehicle 25, the cargo handling robots 30 mounted on the placement portions 44 in no operation state may be charged.

The towing vehicle system of the present embodiment has the following advantageous effects.

(1) While the cargo handling robots 30 mounted on the placement portions 44 in the cargo handling robot mounting vehicle 26 are in no operation state, the power controller 35 controls the power supply device 31 to supply electric power to and charge the cargo handling robots 30. The cargo handling robots 30 in an operation state perform a cargo work by the charged power. After completing the cargo work, the cargo handling robots 30 are charged in the placement portions 44 in the cargo handling robot mounting vehicle 26. Accordingly, the cargo handling robots 30 are effectively charged by utilizing the no operation state, in which, for example, the cargo handling robots 30 are carried or the like. The cargo handling robots 30 may autonomously move from the cargo handling robot mounting vehicle 26 to perform a cargo work, and then, return back to the placement portions 44 after completing the cargo work, or alternatively may perform the cargo work, while remaining on the placement portions 44.

(2) The power supply vehicle 25 on which the power supply device 31 is mounted has a function of supplying power to the cargo handling robots 30. The cargo handling robot mounting vehicle 26 has a function of mounting the cargo handling robots 30 thereon. Thus, the present embodiment may provide functions separately to each of the power supply vehicle 25 and the cargo handling robot mounting vehicle 26. The towed vehicle 12 is configured of the power supply vehicle 25 and the cargo handling robot mounting vehicle 26. This configuration further reduces a turning radius of the towed vehicle 12.

(3) The power supply device 31 has the self-power generating device 33 that self-generates electric power. With this configuration, the self-power generating device 33 may generate electric power, so that the cargo handling robots 30 are always charged while the cargo handling robots 30 are mounted on the placement portions 44 in the cargo handling robot mounting vehicle 26 and are in no operation state.

(4) The trailers 13 configured to carry the containers C corresponding to the objects to be loaded and unloaded are connected to a rear portion of the cargo handling robot mounting vehicle 26 of the towed vehicle 12. This configuration shortens a distance between a position where the cargo handling robots 30 are charged and the trailers 13 around which a cargo work is performed, reducing time required for movement of the cargo handling robots 30 in a case where the cargo handling robots 30 get off the cargo handling robot mounting vehicle 26 and move to the cargo workspace E1 (E2).

(5) The cargo handling robots 30 are charged by contactless charging. This means that the power line of the cargo handling robots 30 does not need a direct contact with the power line 45 of the cargo handling robot mounting vehicle 26. In addition, the power supply vehicle 25 may supply power to the towing tractor 11, solving power shortage of the towing tractor 11.

The present disclosure is not limited to the specific embodiment described above, and may appropriately be modified within the gist of the present disclosure. For example, the following modification may be allowed.

The above embodiment is the exemplary embodiment including the towing tractor as the towing vehicle used in an airport, the towed vehicle pulled by the towing tractor, and the trailers as the carrying cart on which air cargoes are placed. However, the present disclosure is not limited to this embodiment. The towing vehicle may be, for example, a small towing vehicle used in a factory, market, and the like. The carrying cart on which cargoes other than containers are mounted may be used.

In the above embodiment, the cargo handling robots being a humanoid is used. However, the present disclosure is not limited to this embodiment. For example, an arm type robot may be used as the cargo handling robot. In this case, the arm type cargo handling robot should preferably have a mechanism for getting on and off the towed vehicle and moving. In addition, both the humanoid and the arm type robot may be mounted on the towed vehicle and charged.

In the above embodiment, the electric towing tractor is used as the towing vehicle. However, the towing tractor is of an engine type. In this case, the power line connecting between the towing tractor and the power supply vehicle is not required.

In the above embodiment, the towed vehicle includes two vehicles, namely, the power supply vehicle and the cargo handling robot mounting vehicle. However, the present embodiment is not limited to this embodiment. For example, the towed vehicle may be a single towed vehicle on which the power supply source and the power control device are mounted and which includes the placement portions on which the cargo handling robots are mounted.

In the above embodiment, the carrying cart is connected to a rear portion of the towed vehicle. However, the present disclosure is not limited to this embodiment. The carrying cart may not be connected to the rear portion of the towed vehicle. In this case, a work for connecting and disconnecting between the towed vehicle and the carrying cart is not required.

In the above embodiment, the power supply source has the self-power generating device that self-generates electric power. However, the present disclosure is not limited to this embodiment. The power supply source may not have the self-power generating device, and may only have a power storage, apparatus such as a secondary battery or the like. In this case, the power supply source should preferably be rechargeable or replaceable.

What is claimed is:

1. A towing vehicle system comprising:
a towing vehicle; and
a towed vehicle pulled by the towing vehicle, wherein
the towed vehicle includes:
a placement portion on which a cargo handling robot that is rechargeable is mounted;
power supply source mounted on the towed vehicle and configured to supply electric power to the cargo handling robot; and
a power controller configured to control supply of electric power from the power supply source, and
while the cargo handling robot mounted on the placement portion is in no operation state, the power controller supplies electric power to and charges the cargo handling robot.

2. The towing vehicle system according to claim 1 wherein
the towed vehicle includes:
a power supply vehicle on which the power supply source is mounted; and
a cargo handling robot mounting vehicle connected to the power supply vehicle and including the placement portion.

3. The towing vehicle system according to claim 1, wherein
the power supply source has a self-power generating device that self-generates electric power.

4. The towing vehicle system according to claim 1, wherein
a carrying cart configured to carry an object to be loaded and unloaded is connected to a rear portion of the towed vehicle.
